(19) United States
(12) Patent Application Publication
(10) Pub. No.: US 2012/0130704 A1
(43) Pub. Date: May 24, 2012

(54) REAL-TIME TRANSLATION METHOD FOR MOBILE DEVICE

(75) Inventors: Po-Tsang LEE, TAIPEI CITY (TW); Yuan-Chi TSAI, TAIPEI CITY (TW); Meng-Chen TSAI, TAIPEI CITY (TW); Ching-Hsuan HUANG, TAIPEI CITY (TW); Ching-Yi CHEN, TAIPEI CITY (TW); Ching-Fu HUANG, TAIPEI CITY (TW)

(73) Assignee: INVENTEC CORPORATION, TAIPEI CITY (TW)

(21) Appl. No.: 13/087,388

(22) Filed: Apr. 15, 2011

(30) Foreign Application Priority Data
Nov. 23, 2010 (TW) 099140407

(51) Int. Cl. G06F 17/28

(52) U.S. Cl. 704/3

(57) ABSTRACT

A real-time translation method for a mobile device is disclosed. In this method, a location of the mobile device is provided by a global positioning system (GPS). Then, an image is captured, and characters shown in the image are recognized in accordance with a language used in the location of the mobile device. Thereafter, the characters recognized are translated in accordance with a translation database. Then, a translation result of the characters recognized is displayed.

### RELATED APPLICATIONS

This application claims priority to Taiwan Application Serial Number 099140407, filed Nov. 23, 2010, which is herein incorporated by reference.

### BACKGROUND

1. Field of Invention

The present invention relates to a translation method. More particularly, the present invention relates to a real-time translation method for a mobile device.

2. Description of Related Art

Along with the development of 3C (Computer, Communications and Consumer) industries, more and more people use a mobile device as an assistance tool in their daily life. For example, common mobile device include a personal digital assistant (PDA), a mobile phone, a smart phone and so on, and these mobile devices are small in size and easy to carry, so that the number of people using a mobile device becomes larger and larger and more functions are required accordingly.

Among theses functions, an image capturing function has become one of the basic functions for the mobile device. Therefore, it is an important topic regarding how to effectively improve auxiliary functions of the image capturing function. For example, the image capturing function may be combined with an optical character recognition technique, so as to enable the mobile device to have a character recognition function. Further, translation software can be employed to enable the mobile device to translate characters in an image.

However, the optical character recognition technique still has a certain error rate of recognition, and especially, when non-English characters are being recognized, the error rate of recognition is still high, and thus it is difficult for the translation software to correctly translate the recognized characters. Therefore, there is a need to effectively improve accuracy of the real-time translation function of the mobile device.

### SUMMARY

Accordingly, the present invention is directed to providing a real-time translation method for a mobile device, thereby improving accuracy of a real-time translation function of the mobile device.

According to an embodiment of the present invention, a real-time translation method for a mobile device is provided. The method includes providing a location of the mobile device by a global positioning system (GPS); selecting a language desired to be recognized according to the location region for which the language is defined; capturing an image; recognizing a plurality of characters shown in the image; providing a translation database for translating the characters recognized; and displaying a translation result of the characters recognized.

The translation database includes a plurality of region levels arranged in a sequence from large region to small region. When the characters are being translated, the characters are compared with the translation database in a sequence from the smallest level of the region levels to a larger one of the region levels. Then, the step of capturing the image includes capturing an image at a predetermined interval; and capturing an image at a non-predetermined interval. The step of recognizing the image is to recognize the image at the predetermined interval. The step of translating the recognized characters is to translate the characters shown in the image at the predetermined interval. The real-time translation method for the mobile device further includes providing a coordinate of the characters; highlighting a range of the coordinate of the image at the non-predetermined interval; and filling the translation result in the range of the coordinate. The step of recognizing the characters includes judging whether the characters are a phrase or a word. When the characters are the phrase, a fuzzy match is performed between the characters and the translation database. When the characters are the word, a fuzzy match is performed between the characters and the translation database. The real-time translation method for the mobile device further includes establishing the translation database according to different countries.

In the present invention, the real-time translation is performed based on a country provided by the GPS and a translation database corresponding to the country, so that a user can quickly get a correct translation result when traveling abroad. Although the result of optical character recognition software cannot be 100% correct, the accuracy of the translation can be effectively improved by a self-established translation database together with a fuzzy match. Moreover, the self-established translation database translates words with specific purposes, thereby enabling the translation to have clear meaning with respect to the location of the mobile device.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a flow chart showing a real-time translation method for a mobile device according to a first embodiment of the present invention;

FIG. 2 is a flow chart showing a real-time translation method for a mobile device according to a second embodiment of the present invention; and

FIG. 3 is a flow chart showing a real-time translation method for a mobile device according to a third embodiment of the present invention.

### DETAILED DESCRIPTION

Hereinafter, the spirit of the present invention will be illustrated clearly with reference to the drawings and embodiments. Those skilled in the art can make alternations and modifications under the teaching of the present invention with reference to the embodiments, and these alternations and modifications shall fall within the spirit and scope of the present invention.

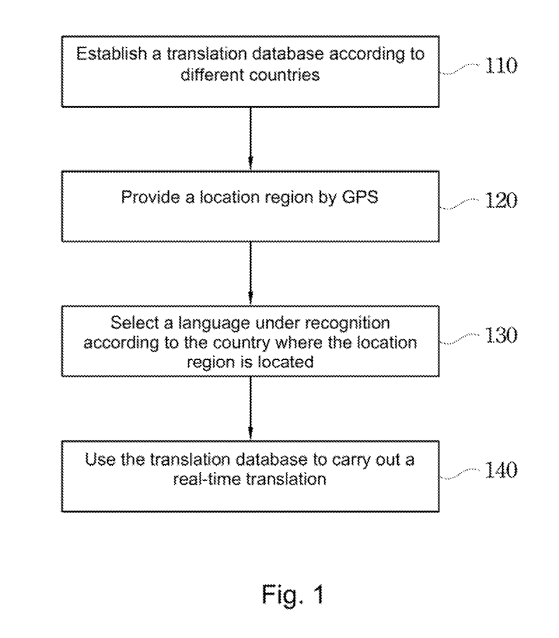

Referring to FIG. 1, FIG. 1 is a flow chart showing a real-time translation method for a mobile device according to a first embodiment of the present invention. In step 110, a translation database is established according to different countries. In step 120, a location of the mobile device is provided by a global positioning system (GPS). In step 130, a language desired to be recognized is selected according to the location region. In step 140, a the translation database is used for performing real-time translation.

The translation database in step 110 may be a brief database built in advance with respect to contents of bulletins, maps or entry names posted in some important areas of travel, such as airports, hotels, scenic spots and restaurants. In step 120, a coordinate of the location is provided by the GPS and then the coordinate is converted into a region at which the mobile device is located, thereby deducing the country where the region is located. In step 130, a language desired to be recognized is selected according to the country where the location (region) is located.

In step 140, a camera lens of the mobile device is used to preview the captured image, and the characters shown in the image are recognized by an optical character recognition software. A fuzzy match is performed between the recognized characters and the translation database, and, when a matched result between the recognized characters and the translation database is found, a translation result is outputted in the image, so that the user can understand the meaning of the (foreign) characters in real time. In this way, when the user reads a notification, map or menu abroad, the user can obtain the translation information in real time through the preview function of the mobile device, so as to settle the needs for food, clothing, lodging and transportation.

It should be noted that, the translation database is preferably not directly linked to an online dictionary, but instead, the translation is made based on the vocabulary established according to different regions. For example, as to the aforementioned airports, hotels, scenic spots and restaurants, the present invention can establish a translation database with respect to the vocabulary used in the bulletin boards posted at those areas, instructions of hotel rooms, and menus of restaurants.

The translation database can be built by first translating the vocabulary artificially or by a computer and then modifying artificially. Therefore, the translation of the foreign vocabulary is the one and only clear translation of its contents, thus enabling the user to understand the meanings thereof. In addition, more importantly, the present invention can translate a whole phrase according to the frequently used phrases (e.g. the contents on a notice board). Since the whole phrase can be directly translated based on the translation database, the translation result after artificial adjustment for user's understanding can be obtained. Thus, the conventional situation that the translation result is difficult to be understood due to different grammars of different languages can be prevented.

In addition, since the same single word may have different meanings in different regions, the translation database includes a plurality of region levels which are arranged in a sequence from large region to small region according to different sizes of the regions. For example, if the location, Chicago, Ill. of the United States is positioned by the GPS, the region levels are the United States, Illinois and Chicago in sequence from large region to small region. In the step of comparing the recognized characters with the translation database, the vocabulary comparison is preferably started from the smallest region level, that is, Chicago. If no comparison result can be found, the vocabulary comparison is performed in a larger region level, Illinois. If the comparison is still not successful, the vocabulary comparison is performed in the largest region level, the United States. In addition to the classification of the region levels based on the sizes of the regions, in other embodiments, the vocabulary also can be classified based on tags, e.g. based on the tags of food, clothing, lodging and transportation.

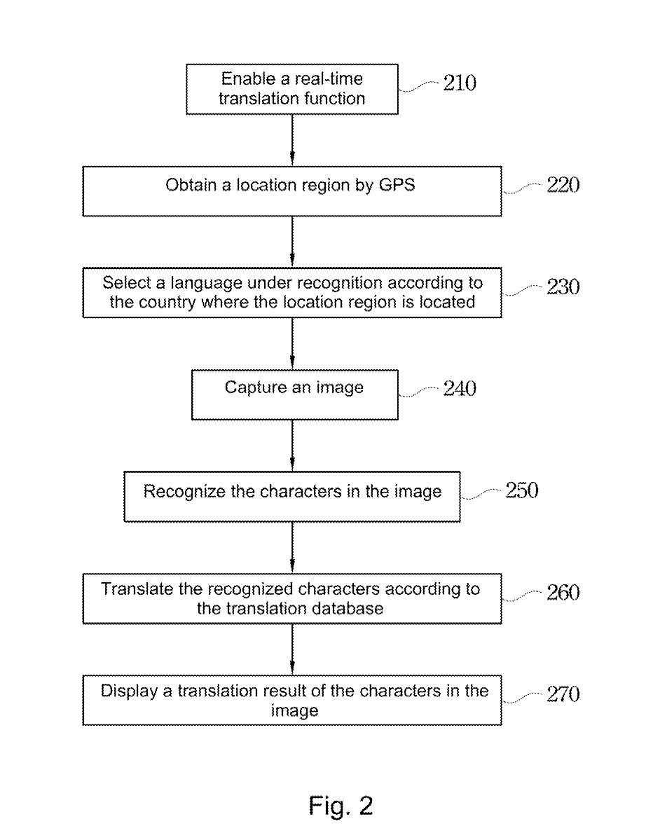

Referring to FIG. 2, FIG. 2 is a flow chart showing a real-time translation method for a mobile device according to a second embodiment of the present invention. In step 210, a real-time translation function is enabled. Then, in step 220, a location is obtained by the GPS, wherein a coordinate of the location is provided by the GPS and then is converted into the country and city where the coordinate is located.

In step 230, a language desired to be recognized is selected according to the country where the location is located, and the contents corresponding to the language is obtained from the translation database. The translation database includes a plurality of region levels, and the region levels are arranged in a sequence from large region to small region according to different regions or different classifications. In step 230, the translation database is written into a temporary file.

In step 240, an image is captured, wherein a camera lens of the mobile device is used to capture the image and save it as an image file.

In step 250, the characters shown in the image are recognized, wherein the characters desired to be recognized are set up by the optical character recognition software according to the characters of the country where the location of the mobile device is located, and the result of the recognized characters is sent back to the temporary file. For example, if the country where the location of the mobile device is located is Japan, the contents of a bulletin should be mainly in Japanese in combination with some English words. Thus, during the optical character recognition, a recognition based on Japanese is first performed once and then a another recognition based on English is performed once.

In step 260, the characters recognized are translated according to the translation database, wherein the comparison is performed from the smallest of the region levels to a larger one of the region levels in the translation database until a matched translation result is found. In step 260, it is judged whether the characters are a phrase or a word. If the characters are the phrase, a fuzzy match is performed between the phrase recognized and the translation database. If the characters are the word, a fuzzy match is performed between the word recognized and the translation database. For example, if the characters obtained by the optical character recognition are a 2-word phrase, the comparison is preferentially made with the 2-word phrases in the translation database, and if there is no matched result, the comparison is made for the 3-word phrases in the translation database, and so forth.

In step 270, the translation result of the characters in the image is displayed, wherein the original characters are highlighted and then the translation result is filled therein, or the translation result is displayed in a dialog box.

In the present invention, by establishing a translation database in advance in combination with a fuzzy match, a recognition error of the optical character recognition software can be easily corrected, so that the translation result may meet the actual requirements of the user more satisfactorily.

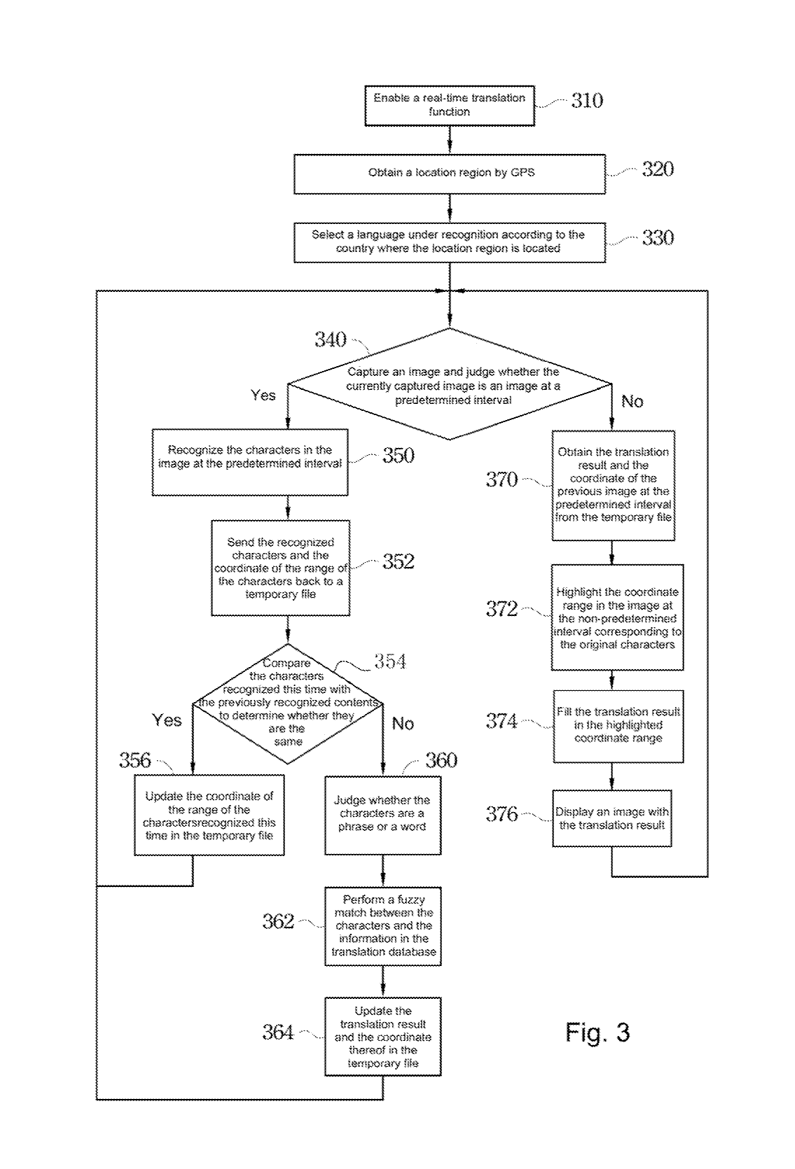

Referring to FIG. 3, FIG. 3 is a flow chart showing a real-time method for a mobile device according to a third embodiment of the present invention. Since an optical character recognition needs certain time, in consideration of the speed of the optical character recognition, only one image is compared and recognized in a period of time. This embodiment is an application in consideration of the efficiency of the optical character recognition.

In step 310, a real-time translation function is enabled. Then, in step 320, a location of the mobile device is obtained by the GPS, wherein a coordinate of the location of the mobile device is provided by the GPS and then is converted into the country and then the city where the coordinate is located.

In step 330, a language desired to be recognized is selected according to the country where the location of the mobile device is located. The translation database includes contents corresponding to the language and has a plurality of region levels, wherein the region levels are arranged in a sequence from large region to small region according to different regions or different classifications. In step 330, the contents of the translation database corresponding to the language is written into a temporary file.

In step 340, an image is captured and it is judged whether the currently captured image is an image at a predetermined interval. The step of capturing the image includes capturing the image by a camera lens of the mobile device and saving it as an image file. In other words, the image captured by the camera lens of the mobile device includes an image at the predetermined interval which matches a preset interval; and an image at a non-predetermined interval which does not match the preset interval. For example, when the predetermined interval is set to 20, the 1st image, 21st image, 41st image, . . . are taken as the images at the predetermined interval for comparison and recognition in step 350, and the rest of the images are taken as the images at the non-predetermined interval for step 370.

In step 350, the characters in the image at the predetermined interval are recognized, wherein the characters desired to be recognized are set up by the optical character recognition software according to the characters of the country where the location of the mobile device is located, and a result of the recognized characters is sent back to the temporary file. For example, if the country where the location is located is Japan, the contents of a bulletin should be mainly in Japanese in combination with some English words. Thus, during the optical character recognition, a recognition based on Japanese is first performed once and then another recognition based on English is performed once.

In step 352, the recognized characters and the coordinate of the range of the characters are sent back to the temporary file. In step 354, the characters recognized at this time are compared with the previously recognized content to determine whether they are the same. If the characters recognized at this time is the same as the previous ones, step 356 is performed, wherein only the coordinate of the range of the characters recognized at this time needs to be updated in the temporary file. If the characters recognized at this time is different from the previous ones, step 360 is performed, wherein the characters in the image at the predetermined interval are translated. In step 360, it is judged whether the characters are a phrase or a word. Then, in step 362, a fuzzy match between the characters and the information in the translation database is performed, wherein a comparison is performed according to the region levels in the translation database in a sequence from the smallest level of the region levels to a larger one of the region levels until a matched translation result is found. In step 364, the translation result and the coordinate thereof are updated in the temporary file.

Returning back to step 340, if the image captured at this time is an image at the non-predetermined interval, step 370 is performed, wherein the translation result and the coordinate of the previous image at the predetermined interval are obtained from the temporary file.

In step 372, the coordinate range in the image at the non-predetermined interval corresponding to the original characters is highlighted. Then, in step 374, the translation result is filled in the highlighted coordinate range. Finally, in step 376, an image with the translation result is displayed.

In consideration of the speed of the optical character recognition, in this embodiment, the image at the predetermined interval is recognized and translated, and in regard to the image at the non-predetermined interval, only the coordinate and the translation result in the temporary file are read and then displayed.

It should be known from the aforementioned preferred embodiments of the present invention that the application of the present invention has the following advantages. In the present invention, a real-time translation is performed based on a location of a mobile device selected by a GPS and the corresponding contents of a translation database, so that a user can quickly get a correct translation result when traveling abroad. Although the result of the optical character recognition software cannot be 100% correct, yet accuracy of the translation can be effectively improved by the self-established translation database together with a fuzzy match. Moreover, the self-established translation database is used to translate words for a specific purpose, so that the translation has a clear meaning with respect to the location of the mobile device.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A real-time translation method for a mobile device, comprising:
providing a location of the mobile device by a global positioning system;
selecting a language desired to be recognized according to the location for which the language is defined;
capturing an image;
recognizing a plurality of characters shown in the image;
providing a translation database for translating the characters; and
displaying a translation result of the characters.

2. The real-time translation method for the mobile device of claim 1, wherein the translation database comprises a plurality of region levels arranged in a sequence from large region to small region.

3. The real-time translation method of claim 2, wherein the characters are compared with the translation database in a sequence from the smallest level of the region levels to a larger one of the region levels when the characters are being translated.

4. The real-time translation method of claim 3, wherein the step of capturing the image comprises:
capturing an image at a predetermined interval; and
capturing an image at a non-predetermined interval.

5. The real-time translation method of claim 4, wherein the step of recognizing the image is to recognize the image at the predetermined interval.

6. The real-time translation method of claim 5, wherein the step of translating the characters is to translate the characters shown in the image at the predetermined interval.

7. The real-time translation method of claim 6, further comprising:
providing a coordinate of the characters.

8. The real-time translation method of claim 7, further comprising:
highlighting a range of the coordinate of the image at the non-predetermined interval; and
filling the translation result in the range of the coordinate.

9. The real-time translation method of claim 8, wherein the step of recognizing the characters comprises:
judging whether the characters are a phrase or a word.

10. The real-time translation method of claim 9, wherein a fuzzy match is performed between the characters and the translation database when the characters are the phrase.

11. The real-time translation method of claim 8, wherein fuzzy match is performed between the characters and the translation database when the characters are the word.

12. The real-time translation method of claim 1, wherein the step of capturing the image comprises:
capturing an image at a predetermined interval;
and capturing an image at a non-predetermined interval.

13. The real-time translation method of claim 12, wherein the step of recognizing the image is to recognize the image at the predetermined interval.

14. The real-time translation method of claim 13, wherein the step of translating the characters is to translate the characters in the image at the predetermined interval.

15. The real-time translation method of claim 14, further comprising:
providing a coordinate of the characters.

16. The real-time translation method of claim 15, further comprising:
highlighting a range of the coordinate of the image at the non-predetermined interval; and
filling the translation result in the range of the coordinate.

17. The real-time translation method of claim 1, wherein the step of recognizing the characters comprises:
judging whether the characters are a phrase or a word.

18. The real-time translation method of claim 17, wherein a fuzzy match is performed between the characters and the translation database when the characters are the phrase.

19. The real-time translation method of claim 17, wherein a fuzzy match is performed between the characters and the translation database when the characters are the word.

20. The real-time translation method of claim 1, further comprising:
establishing the translation database according to different countries.
